(19) United States
(12) Patent Application Publication
(10) Pub. No.: US 2024/0077409 A1
(43) Pub. Date: Mar. 7, 2024

(54) CHIRAL MOLECULE DETECTOR AND METHOD FOR DETECTING CHIRAL MOLECULE

(71) Applicant: GUANGZHOU LUXVISIONS INNOVATION TECHNOLOGY LIMITED, Guangzhou (CN)

(72) Inventors: Tzu-Yao Lin, GUANGZHOU (CN); Shih-Chieh Yen, GUANGZHOU (CN)

(73) Assignee: GUANGZHOU LUXVISIONS INNOVATION TECHNOLOGY LIMITED, GUANGZHOU (CN)

(21) Appl. No.: 18/070,441

(22) Filed: Nov. 28, 2022

(30) Foreign Application Priority Data
Sep. 5, 2022 (TW) 111133592

(51) Int. Cl. G01N 21/21; G01N 21/27; G01N 21/33; G01N 21/3563; G01N 21/552

(52) U.S. Cl. CPC G01N 21/21; G01N 21/27; G01N 21/33; G01N 21/3563; G01N 21/554; G01N 2021/216

(57) ABSTRACT

A chiral molecule detector includes a light source, a photodetector, and a carrier. The carrier is configured to reflect at least part of light emitted by the light source to the photodetector. The carrier includes a substrate and a metal reflective layer. An upper surface of the substrate has a periodic hole array containing multiple holes. The metal reflective layer is located on the upper surface of the substrate, and covers a sidewall of the hole and a bottom surface of the hole.

### CROSS-REFERENCE TO RELATED APPLICATION

This application claims the priority benefit of Taiwan application serial no. 111133592, filed on Sep. 5, 2022. The entirety of the above-mentioned patent application is hereby incorporated by reference herein and made a part of this specification.

### BACKGROUND

### Technical Field

The disclosure relates to a chiral molecule detector and a method for detecting a chiral molecule.

### Description of Related Art

Currently, many commercially available drugs (containing various proteins, amino acids, etc.) have chirality. A chiral molecule may be divided into a left-handed molecule and a right-handed molecule that are enantiomers of each other, and the left-handed molecule and the right-handed molecule generally have very similar physical and chemical properties. However, for some chiral molecules, the left-handed molecule and the right-handed molecule cause a human body to have completely different reactions. Therefore, unless there is a way to prove that mixing the left-handed molecule and the right-handed molecule has no adverse effects on the human body, one of the left-handed molecule and the right-handed molecule has to be removed when preparing a drug with the chiral molecule. However, due to the very small size of the chiral molecule, down to the nanometer scale, the interaction between the chiral molecule and incident light is very small, and quantifying the chiral molecule is difficult.

### SUMMARY

The disclosure provides a chiral molecule detector and a method for detecting a chiral molecule, which can improve the signal-to-noise ratio when detecting a chiral molecule with left-handed circularly polarized light and right-handed circularly polarized light.

In at least one embodiment of the disclosure, the chiral molecule detector includes a light source, a photodetector, and a carrier. The carrier is configured to reflect at least part of light emitted by the light source to the photodetector. The carrier includes a substrate and a metal reflective layer. An upper surface of the substrate has multiple holes in an array. The metal reflective layer is located on the upper surface of the substrate and covers a sidewall of the hole and a bottom surface of the hole.

In at least one embodiment of the disclosure, the method for detecting a chiral molecule includes the following steps: a sample containing chiral molecules is placed on an upper surface of a carrier, the carrier includes a substrate and a metal reflective layer, and an upper surface of the substrate has multiple holes in an array; the metal reflective layer is located on the upper surface of the substrate and covers a sidewall of the hole and a bottom surface of the hole; a light source irradiates the sample on the carrier with light, and the light includes left-handed circularly polarized light and right-handed circularly polarized light; and a photodetector receives at least part of the light reflected by the carrier.

Based on the above, by utilizing the structural design of the carrier, the light may generate surface plasmon polaritons (SPPs) and cavity effects on the upper surface of the carrier, so that more light may be absorbed by the sample, thereby improving the signal-to-noise ratio obtained by detection.

### BRIEF DESCRIPTION OF THE DRAWINGS

FIG. 1 is a schematic cross-sectional view of a chiral molecule detector according to an embodiment of the disclosure.

FIG. 2A is a partial perspective view of a carrier according to an embodiment of the disclosure.

FIG. 2B is a schematic partial top view of the carrier of FIG. 2A.

FIG. 3 is a partial perspective view of a carrier according to an embodiment of the disclosure.

FIG. 4 is a flowchart of a method for detecting a chiral molecule according to an embodiment of the disclosure.

### DESCRIPTION OF THE EMBODIMENTS

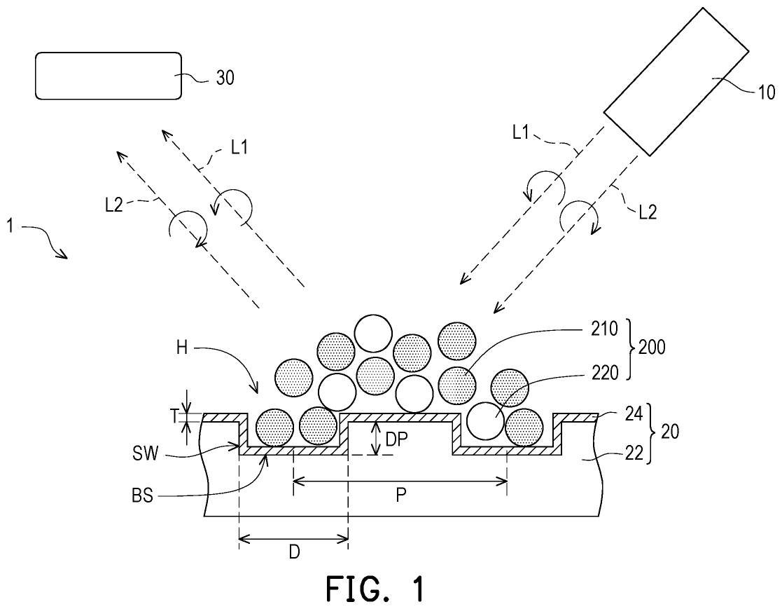

FIG. 1 is a schematic cross-sectional view of a chiral molecule detector 1 according to an embodiment of the disclosure. In FIG. 1, the chiral molecule detector 1 includes a light source 10, a photodetector 30, and a carrier 20. It should be noted that the light source 10, the photodetector 30, and the carrier 20 in FIG. 1 are not shown in actual scale, and the relative sizes of the light source 10, the photodetector 30, and the carrier 20 may be adjusted according to actual needs.

Referring to FIG. 1, the carrier 20 is configured to reflect at least part of light emitted by the light source 10 to the photodetector 30. In some embodiments, the light emitted by the light source 10 includes, for example, ultraviolet light, visible light, or infrared light. The light source 10 may emit light including left-handed circularly polarized light L1 and right-handed circularly polarized light L2 at the same time.

A sample 200 is disposed on the carrier 20. The sample 200 contains left-handed molecules 210 and right-handed molecules 220. In some embodiments, the sample 200 further contains a solvent (not shown), and the left-handed molecules 210 and the right-handed molecules 220 are dispersed in the solvent. In some embodiments, the sample 200 includes, for example, drugs having a chiral structure, such as ethambutol, propranolol, ephedrine, ibuprofen, or zopiclone.

The photodetector 30 is configured to receive the at least part of the light (including the left-handed circularly polarized light L1 and/or the right-handed circularly polarized light L2) reflected by the carrier 20. The photodetector 30 generates circular dichroism spectroscopy based on light obtained. Specifically, since the absorption rates of the sample 200 for the left-handed circularly polarized light L1 and the right-handed circularly polarized light L2 are different, the left-handed circularly polarized light L1 and the right-handed circularly polarized light L2 received by the photodetector 30 have different intensity, and then the content ratio of the left-handed molecules 210 and the right-handed molecules 220 in the sample 200 may be calculated.

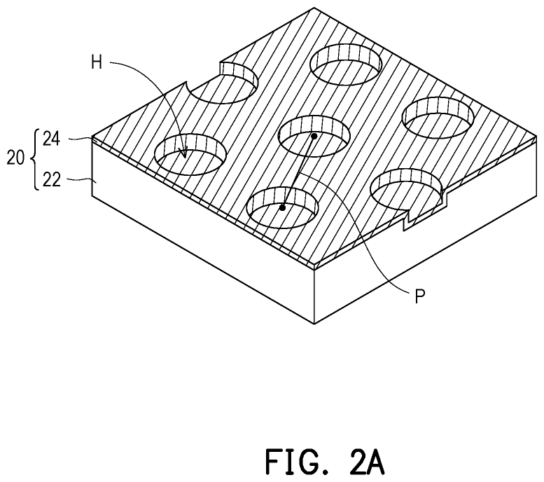

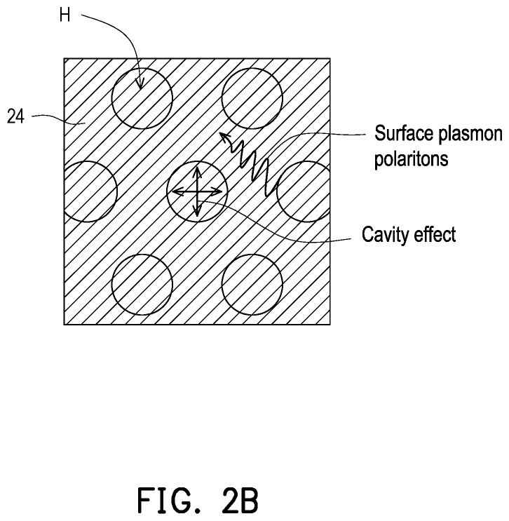

Please refer to FIGS. 1, 2A, and 2B at the same time. The carrier 20 is configured to carry the sample 200. The carrier 20 includes a substrate 22 and a metal reflective layer 24. The substrate 22 is, for example, a silicon substrate, a glass substrate, a polymer substrate, or a substrate of other suitable dielectric materials. An upper surface of the substrate 22 has multiple holes H in an array. A bottom surface of the hole H is a circular shape.

The metal reflective layer 24 is located on the upper surface of the substrate 22. The metal reflective layer 24 contains a single-layer or multi-layer structure. In some embodiments, the metal reflective layer 24 includes gold, silver, aluminum, or an alloy of the foregoing metals or a stacked layer of the foregoing metals. In some embodiments, the method of forming the metal reflective layer 24 includes a sputtering process. In some embodiments, the substrate 22 is rotated during the sputtering process, so that the metal reflective layer 24 can be more completely deposited on a sidewall SW of the hole H of the substrate 22, thereby improving the efficiency of surface plasmon resonance. In some embodiments, a thickness T of the metal reflective layer 24 is 20 nanometer (nm) to 40 nm.

In some embodiments, when the substrate 22 is a silicon substrate and the metal reflective layer 24 includes gold or silver, nickel, chromium or other buffer materials has to be formed on the silicon substrate as an adhesion layer before the gold or silver is formed, and then the gold or silver is formed on the nickel, chromium or other buffer materials, thereby reducing the probability of the gold, silver and other metals being peeled off from the substrate 22 of a silicon substrate.

In some embodiments, the metal reflective layer 24 is in direct contact with the substrate 22 and is conformal to the hole H. For example, when the substrate 22 is a silicon substrate and the metal reflective layer 24 includes aluminum, since aluminum has better adhesion on the silicon substrate, an additional buffer material is not required to be formed on the silicon substrate before the aluminum is formed, thereby reducing the production cost of the carrier 20. In other words, the metal reflective layer 24 containing aluminum may be in direct contact with the silicon substrate. In addition, the surface of aluminum is oxidized into an aluminum oxide film. However, this film does not affect the optical properties of aluminum, and the aluminum oxide located on the surface of aluminum may serve as a protective layer for the inner metal aluminum, so that the metal reflective layer 24 has excellent oxidation resistance, and the durability of the carrier 20 is greatly improved.

In some embodiments, aluminum produces surface plasmon resonance effects in the ultraviolet B (UVB) to infrared wavelength range. In addition, since aluminum is cheap and has excellent adhesion to a silicon substrate compared to other precious metals, choosing a metal aluminum thin film as the metal reflective layer 24 has the advantages of saving cost and improving yield.

In the embodiment, the metal reflective layer 24 covers the sidewall SW of the hole H and a bottom surface BS of the hole H, and makes the upper surface of the carrier 20 become a metasurface. Metasurfaces are microstructures with subwavelength dimensions that may be used to alter optical properties such as the amplitude, phase or direction of propagation of electromagnetic waves. Through near-field optical technology, metasurfaces can effectively change the state of electromagnetic waves when the electromagnetic waves approach. For example, the metasurface can utilize the displacement current of the dielectric material to form magnetic dipole resonance, thereby enhancing the interaction of the sample 200 located thereon with the optical field; alternatively, the metasurface can utilize the localized surface plasmon resonance of metals to enhance the electric field strength of electromagnetic waves in a certain polarization direction, thereby increasing the light absorption rate of the sample 200 located thereon. Therefore, the signal-to-noise ratio of the spectrum obtained by the chiral molecule detector 1 may be improved through the disposition of the metasurface.

In the embodiment, the carrier 20 combines two effects of enhancing electromagnetic wave resonance. Firstly, the light coupling with the holes H that are periodically arranged generates surface plasmon waves, which generate electromagnetic field gains outside the holes H, such as the formation of surface plasmon polaritons (SPPs). Secondly, the cavity effect of the hole H itself causes the electromagnetic wave inside the hole H to generate an electromagnetic field gain. Benefiting from this, whether the sample 200 is located in the hole H of the carrier 20 or outside the hole H, the signal-to-noise ratio can be greatly improved.

In some embodiments, a part of the sample 200 is filled in the hole H, whereby the contact area between the sample 200 and the carrier 20 may be increased. In addition, since the amount of light irradiated on the sample 200 per unit area is increased, the signal-to-noise ratio may be enhanced. In some embodiments, the metasurface formed by the metal reflective layer 24 of the carrier 20 is a hydrophobic structure, which may aggregate the sample 200 and enhance the signal-to-noise ratio.

In some embodiments, by adjusting diameter D, spacing P, and/or depth DP of the hole H, a plasmon resonance band on the surface of the carrier 20 may be controlled, thereby making the left-handed circularly polarized light L1 and right-handed circularly polarized light L2 that are incident be largely absorbed by the sample 200, which improves the signal-to-noise ratio. In some embodiments, the diameter D of the hole H is 150 nm to 350 nm, and the depth DP of the hole H is 200 nm to 1000 nm. In some embodiments, the spacing (or period) P between the holes H is 300 nm to 700 nm, and the spacing P refers to the center distance between two holes H that are adjacent.

In general, a square array has the same period in an X-axial direction and a Y-axial direction. However, the period of the square array in an oblique direction (45 degree angle direction) is larger than the period in the X-axial direction and the Y-axial direction. In the embodiment, the holes H are arranged in a hexagonal arrangement. The hexagonal arrangement has the advantage of uniformity of the periods of the holes H, which improves the efficiency of the surface plasmon resonance of the carrier 20.

In some embodiments, the carrier 20 has the advantage of a large electromagnetic field gain range (or hot spot). For example, the electromagnetic field gain range of the carrier 20 may cover the vertical distance of 1 micrometer (μm) from the upper surface of the carrier 20. Therefore, even if the solution of the sample 200 is thick, the solution can also enter the hot spot of the electromagnetic field, which enhances the signal strength.

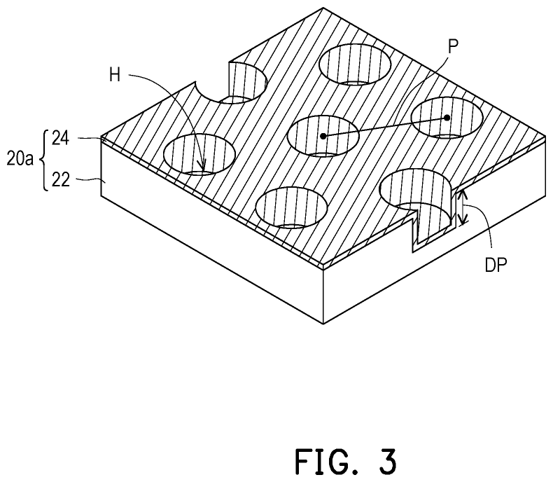

FIG. 3 is a partial perspective view of a carrier according to an embodiment of the disclosure. It should be noted here that the embodiment of FIG. 3 uses the reference numerals and a part of the contents of the embodiment of FIGS. 2A and 2B, the same or similar reference numerals are used to denote the same or similar elements, and the description of the same technical content is omitted. For the description of the omitted part, reference may be made to the foregoing embodiment, and details are not described herein.

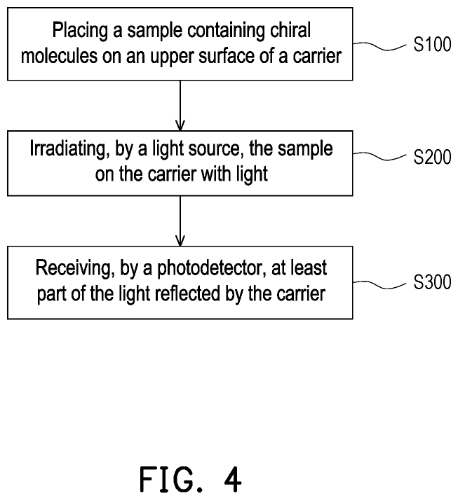

The difference between a carrier 20a of FIG. 3 and the carrier 20 of FIG. 2A is that the depth DP of the hole H of the substrate 22 in the carrier 20a is 1000 nm to 1500 nm. FIG. 4 is a flowchart of a method for detecting a chiral molecule according to an embodiment of the disclosure. Referring to FIG. 4, in step S100, a sample containing chiral molecules is placed on an upper surface of a carrier. For the description of the carrier, reference may be made to any of the foregoing embodiments, and details are not repeated here. In step S200, a light source is configured to irradiate the sample on the carrier with light, and the light includes left-handed circularly polarized light and right-handed circularly polarized light. In step S300, at least part of the light reflected by the carrier is received by a photodetector.

To sum up, when utilizing the carrier of the disclosure to measure the circular dichroism spectroscopy, the difference in the absorption rates of the left-handed molecule and the right-handed molecule for the left-handed circularly polarized light and the right-handed circularly polarized light is greatly increased, which makes the quantification of the left-handed molecule and the right-handed molecule more precise.

What is claimed is:

1. A chiral molecule detector, comprising:
a light source;
a photodetector, and
a carrier, configured to reflect at least part of light emitted by the light source to the photodetector, wherein the carrier comprises:
a substrate, an upper surface of the substrate having a plurality of holes in an array; and
a metal reflective layer, located on the upper surface of the substrate and covering a sidewall of the hole and a bottom surface of the hole.

2. The chiral molecule detector according to claim 1, wherein the bottom surface of the hole is a circular shape, and the holes are arranged in a hexagonal arrangement.

3. The chiral molecule detector according to claim 1, wherein diameter of the hole is 150 nanometer (nm) to 350 nm, and depth of the hole is 200 nm to 1000 nm.

4. The chiral molecule detector according to claim 1, wherein spacing between the holes that are adjacent is 300 nm to 700 nm.

5. The chiral molecule detector according to claim 1, wherein thickness of the metal reflective layer is 20 nm to 40 nm.

6. The chiral molecule detector according to claim 1, wherein a material of the metal reflective layer comprises aluminum.

7. The chiral molecule detector according to claim 1, wherein an upper surface of the carrier is a metasurface.

8. The chiral molecule detector according to claim 1, wherein the substrate comprises a silicon substrate, and the metal reflective layer is in direct contact with the silicon substrate.

9. A method for detecting a chiral molecule, comprising:
placing a sample containing chiral molecules on an upper surface of a carrier, wherein the carrier comprises:
a substrate, an upper surface of the substrate having a plurality of holes in an array; and
a metal reflective layer, located on the upper surface of the substrate and covering a sidewall of the hole and a bottom surface of the hole;
irradiating, by a light source, the sample on the carrier with light, wherein the light comprises left-handed circularly polarized light and right-handed circularly polarized light;
receiving, by a photodetector, at least part of the light reflected by the carrier.

10. The method for detecting the chiral molecule according to claim 9, wherein a part of the sample is filled in the hole.

11. The method for detecting the chiral molecule according to claim 9, wherein the light comprises ultraviolet light, visible light, or infrared light.
